(19) United States
(12) Patent Application Publication
(10) Pub. No.: US 2008/0226383 A1
(43) Pub. Date: Sep. 18, 2008

(54) Binder for Document

(75) Inventors: Hiroshi Shimada, Tokyo (JP); Daichi Kumai, Tokyo (JP); Kouichi Tanimoto, Tokyo (JP)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: KING JIM CO., LTD., Tokyo (JP)

(21) Appl. No.: 11/722,922

(22) PCT Filed: Jan. 25, 2005
(86) PCT No.: PCT/JP05/00910

§ 371 Date: Jun. 27, 2007

(30) Foreign Application Priority Data
Dec. 27, 2004 (JP) 2004-377294

(51) Int. Cl. B42F 3/04

(52) U.S. Cl. 402/31

(57) ABSTRACT

A binder for a document capable of providing excellent usability and workability by improving so that only the advantages of a conventional lever arch type ring binding implement can be utilized to increase the opening of a ring. The binding implement comprises a base part, the ring mounted on the base part and changeable between a closed attitude for binding the document and an open attitude in which the closed ring is partially opened to bind the document, and a switching mechanism mounted on the base part and switching the ring between the closed attitude and the open attitude. The ring comprises a first ring member and a second ring member brought into the open attitude and the closed attitude by the contact of the end parts thereof with each other or the separation of the end parts thereof from each other. The switching mechanism comprises a select lever swingably fitted to the base part. When the ring is in the open attitude, the select lever is so set that it can pass the opened portion of the ring and that the opening/closing speeds of the first ring member and the second ring member of the ring are different from each other.

### TECHNICAL FIELD

The present invention relates to a technology concerning a binder in which, in order to bind a document or the like, a ring that includes ring members in an openable-and-closable manner is opened and closed by operation of a switching lever.

### BACKGROUND ART

A binder having a plurality of ring members is fixedly attached on an inner surface of a cover of a sheet folder or the like. One of such a binder widely known conventionally is a lever-arch type binder in which a ring is opened by operation of a lever.

Such a lever-arch type binder is disclosed in, for example, Japanese Utility Model Application Laid-Open Publication No. 57-24077. The binder disclosed in the document includes: a strip-like base made of a metal plate; two rings, each of which being disposed on the base and includes a plurality of ring members; and an opening/closing mechanism that has an operation lever for switching the rings between a closed ring position and an open ring position. Among the ring members constituting the two rings, the ring members on one side are configured to be rotatable with respect to the base. Accordingly, the rings can be opened and closed by pressing down the operation lever.

### DISCLOSURE OF THE INVENTION

### Problem to be Solved by the Invention

However, these conventional binders still have problems to be solved in the points below. For example, in case where the ring members on one side are configured to be rotatable with respect to the base, as is disclosed in the Japanese Utility Model Application Laid-Open Publication No. 57-24077, the opening of the rings is small and even limited to one side. In addition, the operation lever extends near the rings when the rings are in the opened state. This results in poor workability when filing or removing a document or the like.

In view of the foregoing, an object of the present invention is to contrive ways of utilizing only the advantages of the conventional lever-arch type binders and to provide a binder for a document or the like having a larger ring opening and thus having excellent usability and workability.

### Means for Solving the Problems

In order to solve the problems discussed above, the present invention adopts the following means.

A binder for a document or the like according to the present invention includes: a base; a ring provided on the base, the ring being switchable between a closed ring position for binding a document or the like and an open ring position in which the closed ring is partially opened to allow filing of a document or the like; and a switching mechanism provided on the base, the switching mechanism being used for switching between the closed ring position and the open ring position. The ring has a first ring member and a second ring member that assume the open ring position or the closed ring position by making their ends in contact with or spaced apart from each other. An opening of the ring is positioned above the base and eccentric to one side in relation to a central region of the base with respect to a shorter length direction of the base. The switching mechanism includes a switching lever attached to the base in a swingable manner, and when the ring is in the open ring position, the switching lever is allowed to pass through the opening of the ring.

According to the present invention, the switching lever is allowed to pass through the opening of the ring when the ring is in the open ring position and the opening of the ring is eccentric to one side. This allows a free end of the switching lever to pass through and out of the ring to stay in a retracted state, even in case where the ring has an asymmetrical shape in which the opening of the ring is not located at a central region of the ring. Accordingly, it is possible to prevent the switching lever from taking an obstructive position even during operation of removing or filing a document or the like, thereby dramatically improving workability.

In the present invention, travel distances of the first ring member and the second ring member in their ring opening/closing directions may be set to be different from each other so that the switching lever may be allowed to pass through the opening of the ring. For example, setting the travel distance of the first ring member to be larger than the travel distance of the second ring member may allow the switching lever to pass through the opening of the ring even in case where the opening of the ring is eccentric to the side of the second ring member.

Furthermore, since both the first ring member and the second ring member are used to open and close the ring, it is possible to increase degree of opening of the ring, i.e. maximum distance between the ends of the first and second ring members. This may also be useful for enhancement of usability and workability.

In the present invention, opening/closing speed of the ring may be set to be different between the first ring member and the second ring member so that the switching lever may be allowed to pass through the opening of the ring. For example, the ring member having a larger travel distance may be set to travel faster than the other ring member having a shorter travel distance.

In the present invention, timings of ring opening/closing operations of the first ring member and the second ring member may be set to be different from each other so that the switching lever may be allowed to pass through the opening of the ring. For example, among the first and second ring members, the ring member having a larger travel distance may be set to start traveling at a timing earlier than the other ring member having a shorter travel distance.

In the present invention, it is preferable that the switching lever include a base end hinged to the base and a free end used for operation, and at the base end, a cam may be provided for adjusting degree of opening of each ring in accordance with a swing position of the free end. With this arrangement, it is possible to open and close each ring only by operating the switching lever, thereby providing excellent usability and operability.

It is preferable that the base include a base body made of a metal plate and a bearing rising from the base body, and the bearing may constitute a part of a hinge of the switching lever. With this arrangement, it is possible to form the base body and the bearing by processing a single metal plate, thereby reducing the number of parts used and simplifying the overall structure.

In the present invention, the ring may comprise two rings disposed along a longitudinal direction of the base with a spacing therebetween, and among first ring members and second ring members constituting the two rings, each of the first ring members pair and the second ring members pair may be formed by bending a single metal wire. A continuous portion between the first ring members and a continuous portion between the second ring members may respectively have: press portions arranged close to and parallel to each other at a central region of the base body; and supporting points respectively serving as rotation centers for the first ring members and the second ring members. Each of the supporting points may be held in a rotatable manner with respect to the base body, and the press portions may be pressed by the cam of the switching lever. This arrangement not only leads to reduction of the number of parts used and the cost of manufacturing but also results in enhancement of rigidity of the ring members.

In the present invention, it is preferable that an elastic member be disposed right under the switching mechanism and between the base and the press portions, for biasing the press portions in such a way that causes the ends of the ring members to move away from each other. With this arrangement, it is possible to open and close the rings automatically only by providing an elastic member between the base and the press portions, thereby simplifying the structure of and facilitating the assembling of the switching mechanism having an elastic member.

Alternatively, the switching mechanism may have two supporting members disposed side by side on the base, and each of the supporting members may be inclinable in a lateral direction perpendicular to a longitudinal direction of the base. The first ring members may be supported on one of the supporting members and the second ring members may be supported on the other one of the supporting members. Between both the supporting members and the base, an elastic member may be provided for biasing the supporting members in such a way that causes the ends of the ring members to move away from each other. With this arrangement, it is possible to switch the rings between the closed ring position and the open ring position by putting the two supporting members into motion.

According to the present invention, a binder for a document or the like having a larger ring opening and thus having excellent usability and workability is provided.

### BRIEF DESCRIPTION OF THE DRAWINGS

FIG. 1 is an overall perspective view of a binder according to an embodiment of the present invention;

FIG. 2 is an overall perspective view of the binder according to the embodiment of the present invention;

FIG. 3 is a plan view of the binder according to the embodiment of the present invention;

FIG. 4 is a right side view of the binder according to the embodiment of the present invention;

FIG. 5 is a left side view of the binder according to the embodiment of the present invention;

FIG. 6 is an elevation view of the binder according to the embodiment of the present invention;

FIG. 7 is a right side view of the binder with opened rings according to the embodiment of the present invention;

FIG. 8 is an elevation view of the binder with opened rings according to the embodiment of the present invention;

FIG. 9 is a plan view of a base of the binder according to the embodiment of the present invention;

FIG. 10 is an elevation view of the base of the binder according to the embodiment of the present invention;

FIG. 11 includes a plan view (a), a left side view (b), and a right side view (c) illustrating a switching lever and cam elements of the binder according to the embodiment of the present invention;

FIG. 12 is a cross sectional view of a cam member of the binder according to the embodiment of the present invention;

FIG. 13 includes a plan view (a), cross sectional view (b) focused on a substantial part, and a right side view (c) illustrating the switching lever according to the embodiment of the present invention; and

FIG. 14 is a perspective view illustrating a second embodiment of the present invention;

### BEST MODE FOR CARRYING OUT THE INVENTION

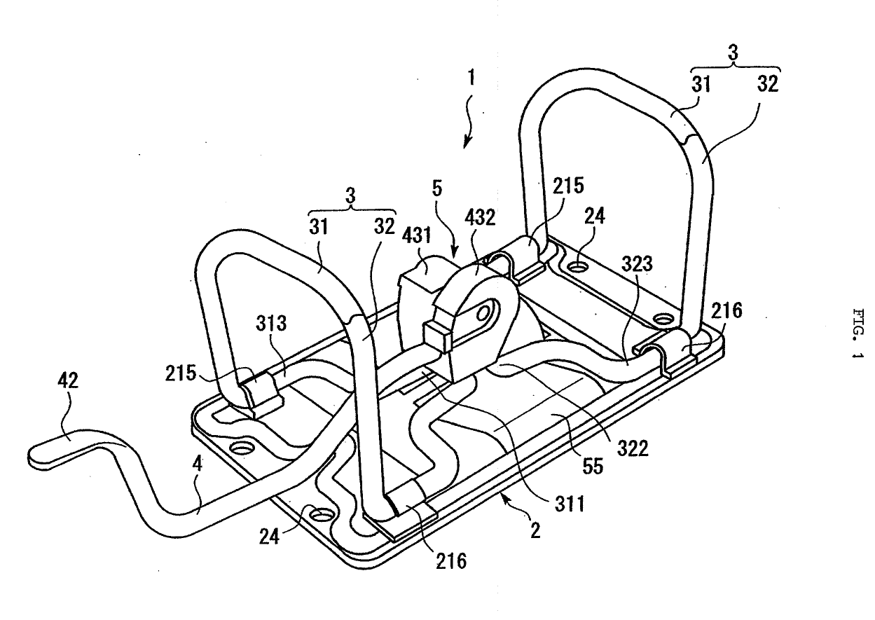

In the following, preferred embodiments of the present invention will be described with reference to the drawings. A binder 1 according to an embodiment comprises: a base (base plate) 2; two rings 3, 3 disposed on the base 2 with a spacing therebetween along a longitudinal direction (length direction) of the base 2; and a switching mechanism 5 including a switching lever 4. The two rings 3 are switchable between a closed ring position for binding a document or the like, as shown in FIG. 1, and an open ring position in which the closed rings are partially opened to allow filing of a document or the like.

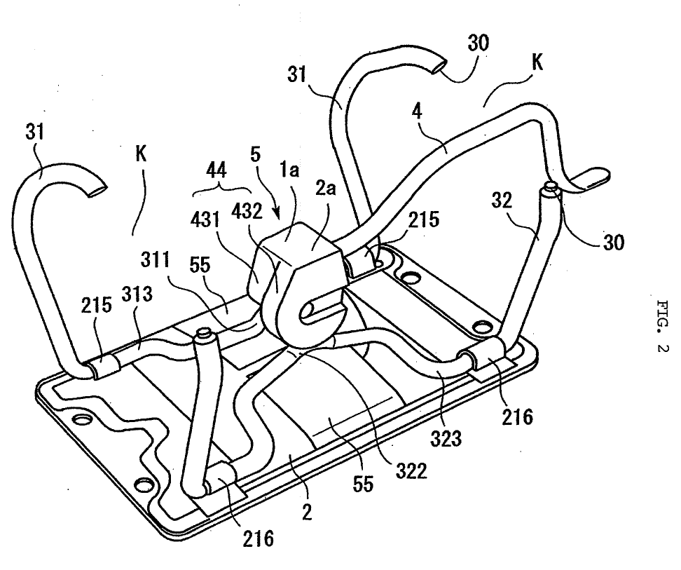

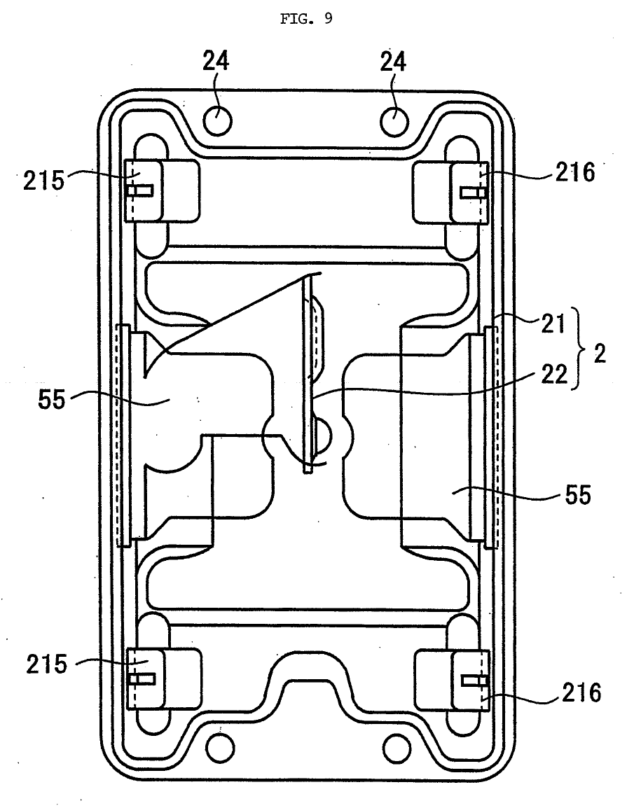

The switching mechanism 5 is disposed on the base 2 and is for switching the rings 3, 3 between the closed ring position and the open ring position. The switching mechanism 5 includes the switching lever 4 attached to the base 2 in a swingable (rotatable) manner. In addition, when the rings 3, 3 are in the open ring position as shown in FIGS. 2, 8, the switching lever 4 is configured to be allowed to pass through an opening K of the rings 3, 3

Next, details of these parts will be described with reference to the drawings.

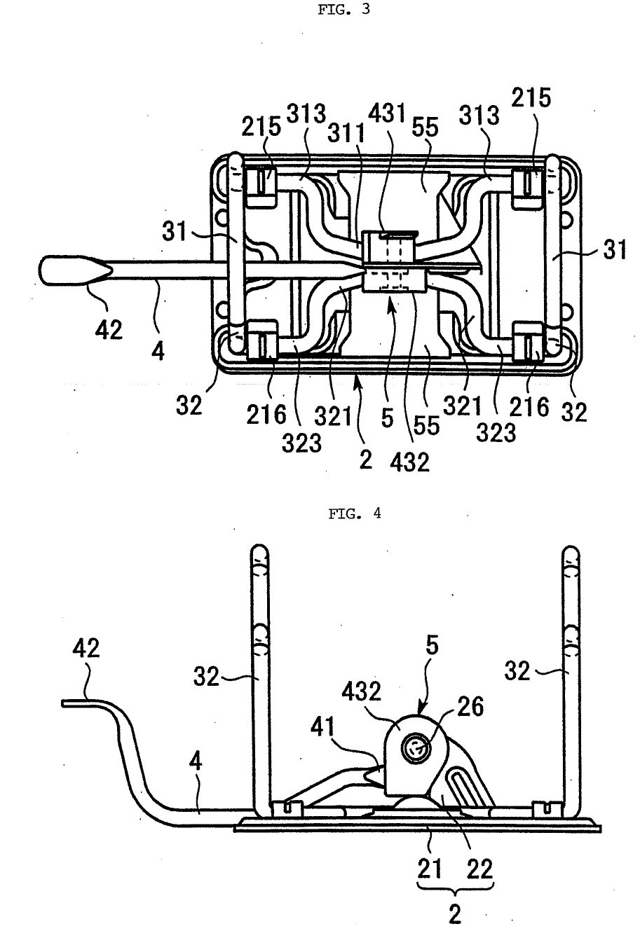

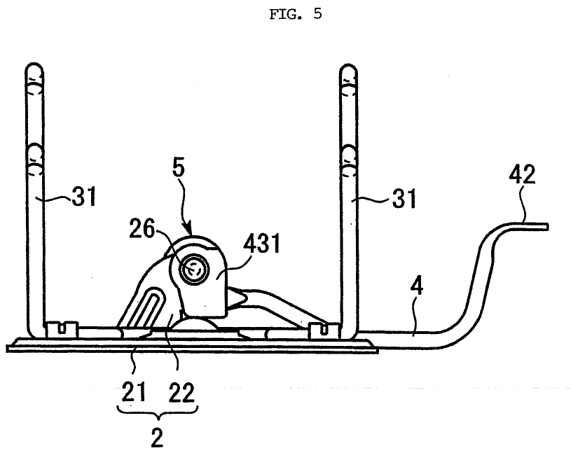

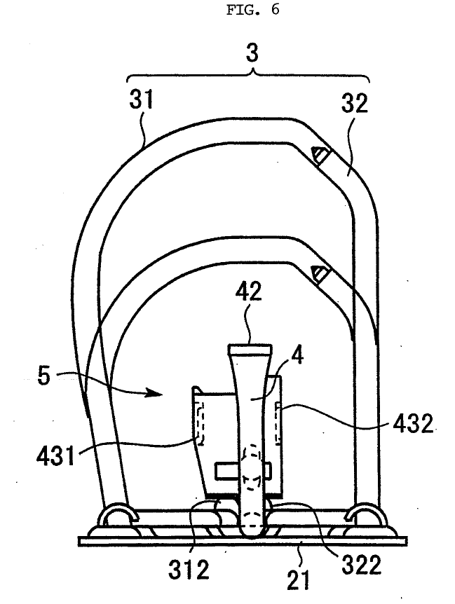

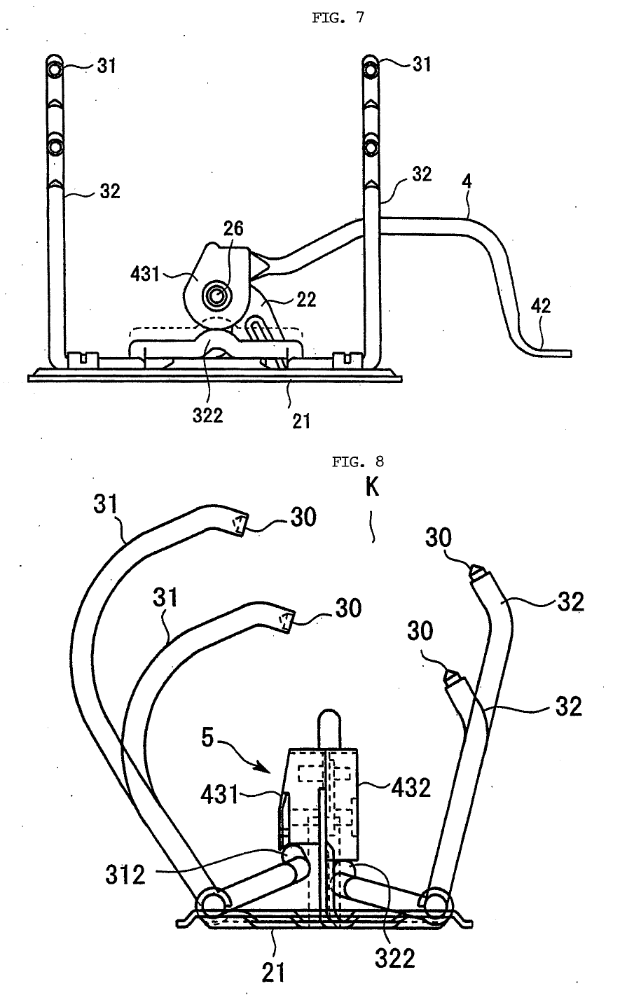

As shown in FIGS. 1 to 10, the base 2 includes: a base body 21 made of a metal plate; and a bearing 23 rising up from the base body 21 in a way positioned at a central region of the base body 21. The base body 21 is formed as a strip-like plate of planar rectangular shape, and has, in both ends thereof, mounting holes 24 for mounting the base body 21 on, for example, an inner surface of a cover of a sheet folder by using screws, rivets, or the like.

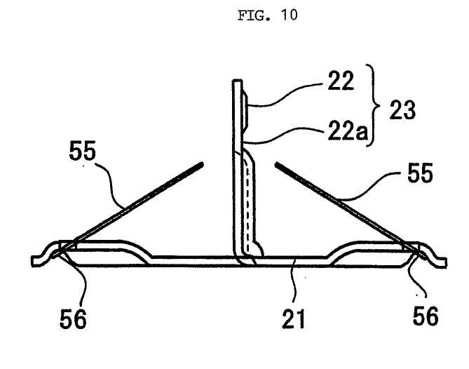

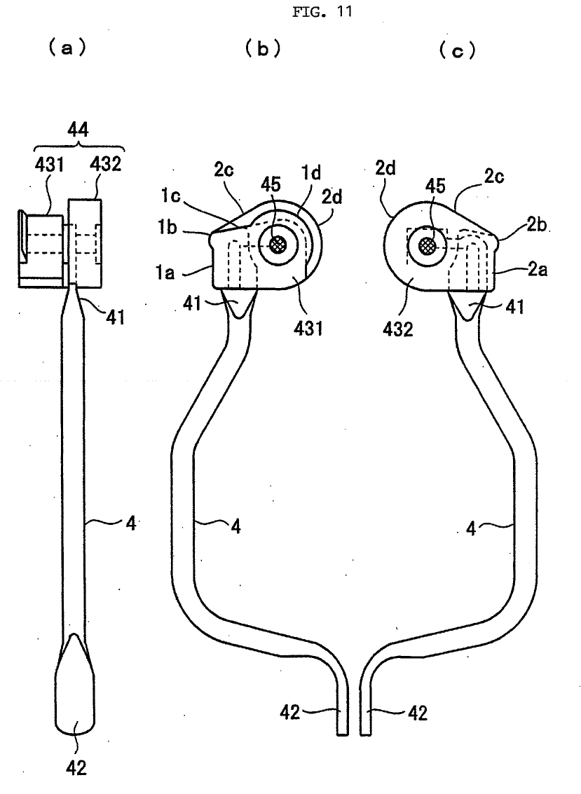

As shown in FIG. 10, the bearing 23 includes: a standing piece 22 cut and pulled up from the base body 21 and thus rising from the central region, with respect to a short direction (i.e. width direction), of the base body 21; and a pin hole 22a provided on the standing piece 22. The bearing 23 is positioned at a central region between the two rings 3, 3 and constitutes a part of a hinge for the switching lever 4. The profile of the standing piece 22 is made low to make the height of the switching mechanism 5 low.

Each ring 3 has a first ring member 31 and a second ring member 32 that assume the closed ring position when their respective ends (tips) 30 are in contact with each other and assume the open ring position when their tips 30 are spaced apart from each other. The switching mechanism 5 is configured to be operable in such a way that causes the tips 30 of the ring members 31, 32 to move closer to and away from each other. With this arrangement, it is possible to give consideration to enhance workability of operation of removing and filing a document or the like by increasing degree of opening of the rings 3 (spacing of the opening K), which is also defined as maximum distance between the tips 30.

As shown in FIG. 6, the ring members 31, 32 are asymmetrically-shaped when viewed from the front. More specifically, each ring 3 is approximately D-shaped, and the opening of each ring 3 is eccentric to the side of a vertical line (second ring member 32) of the D-shape. Accordingly, the opening K (see FIG. 8) of the rings that is formed when the tips 30 of the ring members 31, 32 are spaced apart from each other is located above the base 2 and eccentric to the second ring members 32 side in relation the central region of the base 2 (or base body 21) with respect to the width direction thereof.

In this embodiment, a consideration is given to allow the switching lever 4 to pass through the opening K of the rings even in case where the opening K is eccentric to the second ring members 32 side. That is, the switching mechanism 5 is configured in such a way that causes opening/closing speed of the rings 3, 3 to be different between the first ring members 31 and the second ring members 32. In this case, the first ring members 31 required to take a longer opening distance are set to travel faster than the second ring members 32. It should be appreciated that if the opening K of the rings is eccentric to the first ring members 31 side, the second ring members 32 are set to travel at a faster opening/closing speed than the first ring members 31.

The reason why the opening/closing speed of the rings is set to be different between the first ring members 31 and the second ring members 32 is for purpose of making the arrangement proactively applicable even to a ring shape in which the opening K of the rings 3 is not formed at the central region of the rings 3. This makes the arrangement applicable to binders of various ring shapes. Furthermore, although the rings 3 are approximately D-shaped, since both the first ring members 31 and the second ring members 32 are used to open and close the rings 3, it is possible to increase the degree of opening of the rings 3, i.e. the maximum distance between the ends of the first and second ring members. This is also useful for enhancement of usability and workability.

In this embodiment, the opening/closing speed of the rings 3 is set to be different between the first ring members 31 and the second ring members 32 so that the switching lever 4 can be allowed to pass through the opening K of the rings 3. That is, the first ring members 31 required to take a larger opening distance are set to have a faster opening/closing speed than the second ring members 32. From the viewpoint of allowing the switching lever 4 to pass through the opening K of the rings 3, it is also possible to set travel distances (opening distances) of the first ring members 31 and the second ring members 32 in their ring opening/closing directions to be different from each other. For example, setting the travel distance of the first ring members 31 to be larger than the travel distance of the second ring members 32 can allow the switching lever 4 to pass through the opening K of the rings 3 even in case where the opening K of the rings 3 is eccentric to the second ring members 32 side.

It is also possible to set timings of ring opening/closing operations of the first ring members 31 and the second ring members 32 to be different from each other so that the switching lever 4 can be allowed to pass through the opening K of the rings 3. For example, among the first and second ring members, setting the first ring members 31 having a larger travel distance to be started traveling at a timing earlier than the second ring members 32 having a shorter travel distance can allow the switching lever 4 to pass through the opening K of the rings 3.

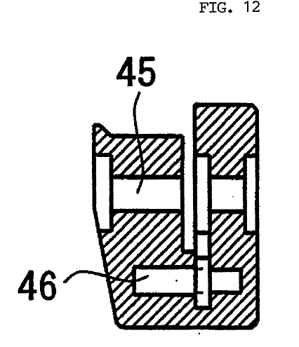

Basically, the above-described factors such as the opening/closing speed of the rings, the travel distances (opening distances) of the first ring members 31 and the second ring members 32 in their ring opening/closing directions, and the timings of ring opening/closing operations of the first ring members 31 and the second ring members 32 are determined by a cam member 44 (see FIGS. 11, 12) that will be described later.

The switching lever 4 has a base end 41 hinged to the base 2 and a free end 42 used for operation, and at the base end 41, a cam member 44 including a first cam element 431 and a second cam element 432 is provided for adjusting the degree of opening and the speeds of opening/closing of each ring 3 in accordance with the swing position of the free end 42. By making the degree of opening and the speeds of opening/closing of each ring 3 adjustable only by operating the switching lever 4, as in this arrangement, it is possible to set the relationship between the operation angle of the switching lever 4 and the opening angle of each ring 3 freely. This makes the arrangement adaptable to various ring shapes.

The switching lever 4 itself is made by bending a metal rod, and the cam member 44 is fixedly attached to the base end 41 of the switching lever 4. The first cam element 431 and the second cam element 432 is provided on the cam member 44. The cam member 44 is made of abrasion-resistant resin. On the cam member 44, a shaft hole 45 is provided through which a hinge pin 26 is to be inserted. Accordingly, the cam member 44 that is fixedly attached to the based end of the switching lever 4 is hinged to the bearing 23 via the hinge pin 26.

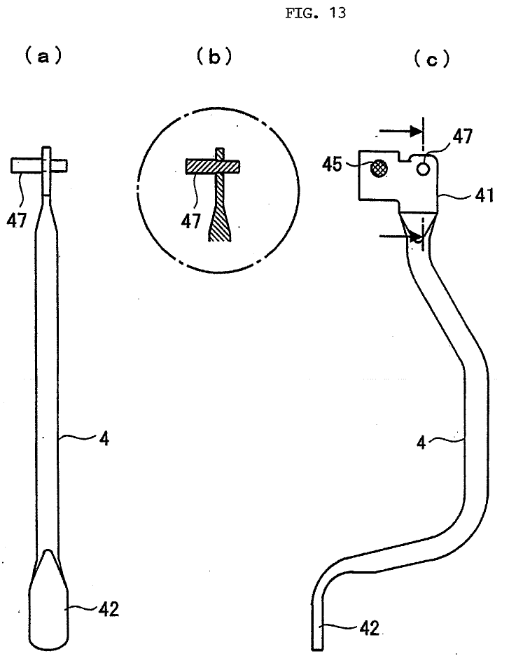

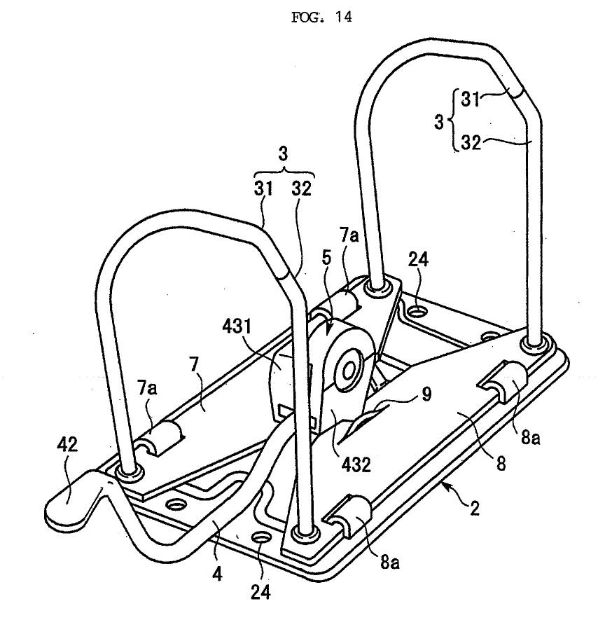

In addition to the shaft hole 45 through which the hinge pin 26 is to be inserted, the cam member 44 is also provided with a fit space 46 as shown in FIG. 12. In the fit space 46, a fitting pin 47 that is provided to the base end of the switching lever 4 is tightly inserted as shown in FIG. 13. Thanks to the interaction of the fit space 46 and the fitting pin 47, it is possible to mount the cam member 44 to the base end of the switching lever 4 with secure and robust positioning. It should be noted herein that a caulking process is used to fix the fitting pin 47 into a hole that is provided in the base end of the switching lever 4.

On the other hand, among the ring members constituting the rings 3, 3, each of the first ring members pair 31, 31 and the two second ring members pair 32, 32 is made by bending a single metal wire. In other words, a continuous portion 311 between the two first ring members 31, 31 and a continuous portion 321 between the two second ring members 32, 32 also serve as supporting members respectively. The continuous portions 311, 321 respectively include press portions 312, 322 that are arranged close to and extend parallel to each other in the central region of the base body 21.

The continuous portion 311 between the first ring members 31, 31 includes two supporting points 313 that are arranged with a spacing therebetween and respectively serving as rotation centers for the first ring members. The supporting points 313 are held in a rotatable manner by bends 215 formed on one side, with respect to the width direction, of the base body 21. The continuous portion 321 between the second ring members 32, 32 includes two supporting points 323 that are arranged with a spacing therebetween and respectively serving as rotation centers for the second ring members 32. The supporting points 323 are held in a rotatable manner by bends 216 formed on the other side, with respect to the width direction, of the base body 21.

The cam member 44 that is fixedly attached to the base end of the switching lever 4 is positioned right above the press portions 312, 322. In this case, the first cam element 431 is opposed to the press portion 312, and the second cam element 432 is opposed to the press portion 322.

The cam surface of the cam member 44 (the first cam element 431 and the second cam element 432) has such a profile that: the press portions 312, 322 can be pressed down to the maximum extent possible when the free end 42 of the switching lever 4 is in the closed position as illustrated; the pressed amounts of the press portions can be decreased gradually to cause the rings 3 to start opening so that the switching lever 4 may not collide with the rings 3; and the press portions can be released from being pressed at the time when the switching lever 4 has passed through the opening of the rings 3. That is, the cam member 44 has such a profile that effects the following functions.

As shown in FIGS. 1, 2, and 11, the cam member 44 includes the first cam element 431 and the second cam element 432 that are integrally made of abrasion-resistant resin. The profile of the first cam element 431 is a shape including: a reference plane surface 1a used for pressing; a plane surface 1c nearly orthogonal to the reference plane surface 1a with a boundary surface 1b interposed therebetween; and a circular cam surface 1d continuous with the plane surface 1c and arc-shaped with the shaft hole 45 as the center.

The profile of the second cam element 432 also is a shape including: a reference plane surface 2a used for pressing; a plane surface 2c nearly orthogonal to the reference plane surface 2a with a boundary surface 2b interposed therebetween; and a circular cam surface 2d continuous with the plane surface 2c and arc-shaped with the shaft hole 45 as the center. The second cam element 432, however, differs from the first cam element 431 on the points below.

The reference plane surface 2a is formed on the same level as the reference plane surface 1a of the first cam element 431, and the boundary surface 2b is also formed of the substantially same shape as the boundary surface 1b of the first cam element 431. The circular cam surface 2d, however, is formed of an arc shape having a larger diameter than that of the circular cam surface 1d of the first cam element 431. Accordingly, the plane surface 2c, that extends from the circular cam surface 2d of a larger diameter to the boundary surface 2b, is formed at a more outwardly bulged position than the plane surface 1c of the first cam element 431.

When the free end 42 of the switching lever 4 is in the position of closing the rings 3 as shown in FIG. 1, the press portions 312, 322 of the rings 3 are pressed down by the plane surfaces 1a, 2a to the maximum extent possible. When the switching lever 4 is swung to a point at which the cam surface in contact with the press portions has gone beyond the boundary surfaces 1b, 2b, the first ring members 31 and the second ring members 32 start moving at different speeds, with the first ring members 31 moving faster than the second ring members 32. This is due to the fact that the plane surface 1c is formed more inward (more closer to the shaft hole 45) than the plane surface 2c.

When the extent to which the press portions are pressed has decreased gradually to cause the rings 3 to start opening so that the switching lever 4 may not collide with the rings 3, and the cam surface in contact with the press portions has reached the circular cam surface 1d, 2d, then the first ring members 31 and the second ring members 32 are opened to the maximum extent possible. At this time, the switching lever 4 is allowed to pass through the opening K. At the time when the switching lever 4 has passed through the opening of the rings 3, the cam surface in contact with the press portions reaches the zone of the circular cam surfaces 1d, 2d. In this zone, since each of the circular cam surfaces 1d, 2d forms a part of an arc, each of which having the shaft hole 45 as the center, the opening K of the rings 3 is maintained as shown in FIG. 2. The operation of closing the rings 3 is the reverse of the operation described above.

With the swing operation of the switching lever 4, the press portions 312, 322 can be pressed down or released from pressing directly by the cam member 44. At this time, the first ring members 31 has a faster speed of opening/closing than the second ring members 32.

Tablet-shaped elastic members (plate springs) 55, 55 are provided between the base body 21 of the base 2 and the press portions 312, 322 so that the rings can be allowed to recover the original position when the press portions are released from pressing.

Each plate spring 55 has an one end 56 positioned on the base body 21 as shown in FIGS. 9, 11. Each plate spring 55 is configured to rise from the one end 56 toward the central region of the base body 21. With this arrangement, it is possible to bias the press portion 312, 322 in such a way that causes the ends of the ring members 31, 32 to move away from each other.

According to the present embodiment, it is possible to switch the rings 3, 3 between the closed ring position and the open ring position only by operating the switching lever 4. In addition, the switching lever 4 is allowed pass through the opening K of the rings 3, 3 when the rings 3, 3, are in the open ring position. This arrangement allows the free end 42 of the switching lever 4 to pass through and out of the rings 3 to stay in a retracted state as shown in FIG. 8 even in case where the rings 3 are in the open ring position. Accordingly, it is possible to prevent the switching lever 4 from taking an obstructive position even during the operation of removing or filing a document or the like.

The arrangement of the present embodiment is advantageous in that the number of parts used can be decreased, the cost of manufacturing can be reduced, and so on.

As an alternative to differing the opening/closing speed between the first ring members 31 and the second ring members 32, another possible way to obtain different timings of opening/closing operations is to form the boundary surface 1b of the first cam element 431 and the boundary surface 2b of the second cam element 432 at positions different from each other. For example, the boundary surface 1b may be formed lower than the boundary surface 2b, or the boundary surface 1b may be formed more closer to the reference plane surface 1a.

In either case, setting the travel distance of the first ring members 31 in its ring opening/closing direction to be larger than that of the second ring members 32 can allow the switching lever 4 to pass through the opening K of the rings even in case where the opening of the rings is eccentric to the second ring members 32 side.

### Second Embodiment

FIG. 14 illustrates a second embodiment of the present invention. In the second embodiment, the parts having the same functions as those in the first embodiment are designated by the same reference numbers in order to simplify their descriptions.

A binder according to the second embodiment also has a base (base plate) 2, two rings 3, 3 disposed on the base 2 with a spacing therebetween along a longitudinal direction of the base 2, and a switching mechanism 5 including a switching lever 4. The two rings 3 are switchable between a closed ring position for binding a document or the like and an open ring position in which the closed rings are partially opened to allow filing of a document or the like.

The switching mechanism 5 is disposed on the base 2 and is for switching the rings 3, 3 between the closed ring position and the open ring position, and includes the switching lever 4 attached to the base 2 in a swingable (rotatable) manner. In addition, when the rings 3, 3 are in the open ring position, the switching lever 4 is allowed to pass through an opening of the rings 3, 3.

In the second embodiment, the switching mechanism 5 has two supporting members 7, 8 disposed side by side on the base 2. Each of the support members 7, 8 is made of a metal plate that is inclinable in a lateral direction perpendicular to the longitudinal direction of the base 2. The first ring members 31 are supported on one supporting member 7 and the second ring members 32 are supported on the other supporting member 8, respectively. Between the supporting members 7, 8 and the base 2 (base body 21), an elastic member 55 (not shown) is provided for biasing the supporting members 7, 8 in such a way that causes the ends of the ring members 31, 32 to move away from each other. The supporting members 7, 8 are connected in a way inclinable in the lateral direction by using hinges 7a, 8a respectively, which are cut and raised from the base body 21.

The supporting members 7, 8 are provided with bulges (only one of them is shown) 9 that are cut and raised therefrom. Among the bulges 9, the bulge 9 of the supporting member 7 lies just below the first cam element 431 and the bulge 9 of the supporting member 8 lies just below the second cam element 432. This allows the supporting members 7, 8 to be pressed by the cam member 44. Accordingly, with this arrangement, it is possible to switch the rings between the closed ring position and the open ring position by putting the two supporting members 7, 8 into motion. In addition, the use of the supporting members 7, 8 made of metal plates can lead to enhancement of stiffness in torsion.

### INDUSTRIAL APPLICABILITY

The present invention is applicable to a sheet folder or the like for binding a document or the like.

1. A binder for a document or the like, comprising
a base;
a ring provided on the base, the ring being switchable between a closed ring position for binding a document or the like and an open ring position in which the closed ring is partially opened to allow filing of a document or the like; and
a switching mechanism provided on the base, the switching mechanism being used for switching between the closed ring position and the open ring position,
wherein the ring includes a first ring member and a second ring member that assume the open ring position or the closed ring position by making their ends in contact with or spaced apart from each other,
an opening of the ring is positioned above the base and eccentric to one side in relation to a central region of the base with respect a shorter length direction of the base, through different opening/closing operations of the first ring member and the second ring member, and
the switching mechanism includes a switching lever attached to the base in a swingable manner, and when the switching lever is swung from a state in which the ring is in the closed ring position, the first ring member and the second ring member open up to form the opening, and the switching lever passes through the opening to reach a retracted state.

2. A binder for a document or the like according to claim 1, wherein travel distances of the first ring member and the second ring member in their ring opening/closing directions are set to be different from each other.

3. A binder for a document or the like according to claim 1, wherein opening/closing speed of the ring is set to be different between the first ring member and the second ring member.

4. A binder for a document or the like according to claim 1, wherein timings of ring opening/closing operations of the first ring member and the second ring member are set to be different from each other.

5. A binder for a document or the like according to claim 1, wherein the switching lever includes a base end hinged to the base and a free end used for operation, and at the base end, a cam is provided for adjusting degree of opening of the ring in accordance with a swing position of the free end.

6. A binder for a document or the like according to claim 1, wherein the base includes a base body made of a metal plate and a bearing rising from the base body, and the bearing constitutes a part of a hinge of the switching lever.

7. A binder for a document or the like according to claim 1, wherein the ring comprises two rings disposed along a longitudinal direction of the base with a spacing therebetween, among first ring members and second ring members constituting the two rings, each of the first ring members pair and the second ring members pair is formed by bending a single metal wire, a continuous portion between the first ring members and a continuous portion between the second ring members respectively have press portions arranged close to and parallel to each other at a central region of the base body and supporting points respectively serving as rotation centers for the first ring members and the second ring members, each of the supporting points is held in a rotatable manner with respect to the base body, and the press portions are pressed by the cam of the switching lever.

8. A binder for a document or the like according to claim 7, wherein the switching mechanism includes an elastic member disposed between the base and the press portions, the elastic member biases the press portions in such a way that causes the ends of the ring members to move away from each other.

9. A binder for a document or the like according to claim 1, wherein the switching mechanism includes two supporting members disposed side by side on the base, each support member is inclinable in a lateral direction perpendicular to a longitudinal direction of the base, the first ring member is supported on one of the supporting members and the second ring member is supported on the other one of the supporting members, and between both of the supporting members and the base, an elastic member is provided for biasing the supporting members in such a way that causes the ends of the ring members to move away from each other.

10. A binder for a document or the like according to claim 1, wherein the switching lever passes through the opening and reaches the retracted state at an opposed position across the ring from the position of the switching lever when the ring is in the closed ring position.

11. A binder for a document or the like according to claim 1, wherein the ring comprises a plurality of rings disposed along a longitudinal direction of the base with a spacing therebetween, and the switching lever assumes a closed ring keeping state, in which the switching lever is at a position outside the plurality of rings and keeps the rings at the closed ring position, and the retracted state, in which the switching lever passes through the opening of the rings while the rings are in the opened ring position and takes an opposed position outside the plurality of rings across the rings from the position of the switching lever in the closed ring keeping state.
